(19) United States
(12) Patent Application Publication
(10) Pub. No.: US 2004/0151821 A1
(43) Pub. Date: Aug. 5, 2004

(54) Green sweet curry-Kaeng Kheaw Wan

(76) Inventor: Napavan Noparatnaraporn, Bangkok (TH)

Correspondence Address: Kasetsart University, Public-Private Technology Development and, Transfer Center (PPTC), 50 Paholyothin Rd., Bangkok, 10900, TH

(21) Appl. No.: 10/356,024

(22) Filed: Feb. 3, 2003

(51) Int. Cl. A23L 1/238

(52) U.S. Cl. 426/589

(57) ABSTRACT

Compositions of Green Sweet Curry comprising protein, fat from animal or plant, medicinal herbs and curry paste. A process is described for making curry paste of green sweet curry and a process of making green sweet curry. A process is also described for stabilizing the curry soup part of green sweet curry to avoid cracking of the emulsion of the cooked curry soup. The green sweet curry has fat in the range 8-10%, protein 35-45%, a total soluble solid of 9.5-11.0%, salt 2.5-4.5%, a pH of 5.50-6.50, degree of lightness, L, of 55-65, degree of redness, a, of 0.5-2.0, and degree of yellowness, b, of 20-30. The viscosity of the curry soup is 60-70 cP (centipoise, at 25° C.). The water activity (A_{w}) is in the range 0.80-1.00.

### BACKGROUND OF THE INVENTION

Currently, people are most conscious on maintaining themselves healthy through careful selection of foods with good nutritional value and especially those that promote good health and protect the body against various diseases such as cancer and many of the degenerative diseases. The medicinal herbs selected as the ingredients for the present invention have been proved to be of great advantageous in maintaining good health since most of them possess high antioxidant activity now widely accepted as protective against numerous diseases caused by free radical damage such as degenerative diseases like Alzheimer's disease, stroke, cataract, macular degeneration, various cardiovascular diseases, cirrhosis, autoimmune disease, cancer, Parkinson's disease, rheumatoid arthritis, and more. The very many different kinds of spices and vegetable used in the green sweet curry—‘Kaeng Kheaw Wan’ makes the present invention very good for health in term of the antioxidant activity and the amount of fiber present.

Coconut cream is used as main ingredient in the presently described curry. The greenish color of the curry soup is from the chili paste used. The way the food is prepared needs to be precise to make it delicious, regarding the preparation of the ingredients, sequence of mixing, pH, time and the temperature in each step of cooking. Since coconut cream is one of the natural emulsion which is a main ingredient of cooking curry, and there has always been problem for canning curry in food manufacturing that emulsion of the curry soup becomes cracked within a short period after cooking and canning. The present invention described the details in preparing one kind of curry called ‘Kaeng Kheaw Wan’ including the way to make the emulsion of the curry soup remains stable all through its shelf-life.

### SUMMARY OF THE INVENTION

Compositions of green sweet curry or ‘Kaeng Kheaw Wan’ are described including a process of making the curry paste of green sweet curry and a process of making the green sweet curry. A process is also described for stabilizing the curry soup part of the green sweet curry to avoid cracking of the emulsion of the cooked curry soup which comprises keeping the curry soup warm at a temperature slightly under its boiling point while transferring the curry soup using pumping action to allow the soup to fall down through the air from a height not less than 50 cm. for a period of at least 5 minutes.

### DESCRIPTION OF THE INVENTION

Curry paste is prepared from chili (Capsicum spp.) preferably the green ones, pepper, onion, garlic, galanga, lemon grass, coriander root, Citrus hystrix rind and leaves, salt and shrimp paste. The amount of each ingredient is as shown in Table 1 as fixed amount or Table 2 as range of the ingredients. All the herbal ingredients in Table 1 are cut into small pieces and blended in a food blender that all are thoroughly mixed. Salt and shrimp paste are gradually added and mixed to give a homogeneous paste having degree of lightness (L), ranging 35-50; degree of redness (a), ranging 1.5-3.5 and degree of yellowness (b) ranging 20-30. The pH of the curry paste is in the range 4.50-6.50.

The curry described in the present invention consists of protein, preferably from animal although soy protein or any protein of plant origin may also be used; fat from animal or plant, but preferably from plant origin like coconut cream to make the green sweet curry most tasty and itself is a main source of energy; medicinal herbs and curry paste in fixed amount as shown in Table 3 and in varied amounts as shown in Table 4. After being processed, the green sweet curry has the percentage of fat in the range 8-10%, a pH of 5.50-6.50, salt 2.5-4.5%, a total soluble solid of 9.5-11.0%, protein 35-45%, degree of lightness, L, of 55-65, degree of redness, a, of 0.5-2.0, degree of yellowness, b, of 20-30. The viscosity of the curry soup is 60-70 cP (centipoise, at 25° C.). The water activity (A_{w}) is in the range 0.80-1.00.

The medicinal plants are selected from the group of plants such as fruits of Solanum spp., basil leaf—Ocimum basilicum Linn., leaf and rind of ‘Ma-krood’—Citrus hystrix DC; fruits of Cayenne Pepper—Capsisum frutescens Linn or chili Spur pepper—Capsicum annuum Linn., garlic—Allium sativum Linn, onion—Allium ascalonicum Linn, galanga—Alpinia galanga Swartz., lemon grass—Cymbopogon citratus Stapf., coriander fruit and root—Coriandrum sativum Linn and fennel—Foeniculum vulgare Mill.

TABLE 1
Components of curry paste in fixed amounts

| | |
|---|---|
| Chili Spur pepper, green | 100 g |
| Chili Spur pepper, yellow | 30 g |
| Cayenne Pepper | 60 g |
| Onion | 60 g |
| Garlic | 30 g |
| Lemon grass | 20 g |
| Coriander root | 10 g |
| Galanga | 10 g |
| Rind of Citrus hystrix DC | 5 g |
| Pepper | 2 g |
| Salt | 5 g |
| Shrimp paste | 20 g |

TABLE 2
Components of curry paste in varied amounts

| | |
|---|---|
| Chili Spur pepper, green | 50-200 g |
| Chili Spur pepper, yellow | 10-50 g |
| Cayenne Pepper | 10-80 g |
| Onion | 10-80 g |
| Garlic | 10-50 g |
| Lemon grass | 10-50 g |
| Coriander root | 5-20 g |
| Galanga | 5-20 g |
| Rind of Citrus hystrix DC | 2-10 g |
| Pepper | 2-10 g |
| Salt | 2-10 g |
| Shrimp paste | 10-80 g |

TABLE 3
Components of green sweet curry in fixed amounts

| | | |
|---|---|---|
| Meat (chicken, pork, beef, shrimp or fish) | 300 | g |
| Coconut cream | 500 | g (2 cups) |
| Fruits of Solanum spp.(S. torvum and/or | 200 | g |
| S. melongana) | | |
| Basil leaves | 80 | g |
| Leaves of Citrus hystrix DC | 10 | g |
| Chili Spur pepper, red | 20 | g |
| Curry paste (as from Table 1) | 50 | g |
| Coriander seed | 4 | g |
| Fennel | 4 | g |
| Vegetable oil | 50 | ml |
| Sugar | 7 | g |
| Fish sauce | 50 | ml |

TABLE 4
Components of green sweet curry in varied amounts

| | | |
|---|---|---|
| Meat (chicken, pork, beef, shrimp or fish) | 200-500 | g |
| Coconut cream | 300-600 | g |
| Fruits of Solanum spp.(S. torvum and/or | 80-200 | g |
| S. melongana) | | |
| Basil leaves | 30-100 | g |
| Leaves of Citrus hystrix DC | 5-30 | g |
| Chili Spur pepper, red | 20-50 | g |
| Curry paste (as from Table 1) | 30-100 | g |
| Coriander seed | 2-10 | g |
| Fennel | 2-10 | g |
| Vegetable oil | 30-70 | ml |
| Sugar | 5-10 | g |
| Fish sauce | 30-80 | ml |

Coriander seeds and fennel are roasted separately in a pan using medium low temperature about 150-200° C. with occasionally stirring until light brownish color is obtained. They are then pulverized and to be added later into the curry. The curry paste is fried with 50 ml vegetable oil using medium low temperature while gradually addding about half of the coconut cream. The pulverized coriander seeds and fennel are added. Meat is cut into 1 inch-cube and added to the mixture. The curry is heated at medium temperature until the meat is well-cooked and the rest of the coconut cream is then added. Add fish sauce and Solanum fruits. The rest of the medicinal plants, i.e. basil leaves, Citrus hystrix leaves, red Chili Spur pepper (cut into thin, long pieces) are added to the curry as a final step in the preparation.

Since there has always been problem on cracking of the curry soup which is a natural emulsion of the coconut cream upon standing after canning leads to non-acceptance of the consumer. A process is developed to stabilize the soup part of the green sweet curry. The process comprises, after the curry is cooked, steps of keeping the curry soup warm at a temperature slightly under the boiling temperature of the curry soup, i.e., at about 100-110 degree Celsius while repeatedly pumping or transferring part of the soup to a level at least 50 cm. above the surface of the curry contained in a vessel and allowing it to fall through the air back to the whole mass of the soup. The transferring action is done for 5-10 minutes. This process causes the curry soup to become homogeneous and stable for at least 24 months after canning without cracking, which is the separation of the oil phase from the aqueous phase, with no need for use of any other synthetic or non-synthetic emulsifying agent(s).

It will be understood the modifications can be made in the above description without departing from the scope of this invention by one of ordinary skill in the art. It is accordingly intended that all matter contained in the above description be interpreted as descriptive rather than in a limiting sense.

It is also to be understood that the following claims are intended to cover all of the generic and specific features of the invention as described herein, and all statements of the scope of the invention which, as a matter of language, might be said to fall therebetween.

We claim:

1. Green sweet curry composition comprising the following ingredients in fixed amounts:

| | | |
|---|---|---|
| Meat (chicken, pork, beef, shrimp or fish) | 300 | g |
| Coconut cream | 500 | g (2 cups) |
| Fruits of Solanum spp.(S. torvum and/or | 200 | g |
| S. melongana) | | |
| Basil leaves | 80 | g |
| Leaves of Citrus hystrix DC | 10 | g |
| Chili Spur pepper, red | 20 | g |
| Curry paste | 50 | g |
| Coriander seed | 4 | g |
| Fennel | 4 | g |
| Vegetable oil | 50 | ml |
| Sugar | 7 | g |
| Fish sauce | 50 | ml |

2. Green sweet curry composition comprising the following ingredients in varied amounts:

| | | |
|---|---|---|
| Meat (chicken, pork, beef, shrimp or fish) | 200-500 | g |
| Coconut cream | 300-600 | g |
| Fruits of Solanum spp.(S. torvum and/or | 80-200 | g |
| S. melongana) | | |
| Basil leaves | 30-100 | g |
| Leaves of Citrus hystrix DC | 5-30 | g |
| Chili Spur pepper, red | 20-50 | g |
| Curry paste | 30-100 | g |
| Coriander seed | 2-10 | g |
| Fennel | 2-10 | g |
| Vegetable oil | 30-70 | ml |
| Sugar | 5-10 | g |
| Fish sauce | 30-80 | ml |

3. Green sweet curry composition of claim 1, whereof said curry paste used comprising the ingredients in fixed amounts as follows:

| | |
|---|---|
| Chili Spur pepper, green | 100 g |
| Chili Spur pepper, yellow | 30 g |
| Cayenne Pepper | 60 g |
| Onion | 60 g |
| Garlic | 30 g |
| Lemon grass | 20 g |
| Coriander root | 10 g |
| Galanga | 10 g |
| Rind of Citrus hystrix DC | 5 g |
| Pepper | 2 g |
| Salt | 5 g |
| Shrimp paste | 20 g |

4. Green sweet curry composition of claim 1, whereof said curry paste used comprising the ingredients in varied amounts as follows:

| | |
|---|---|
| Chili Spur pepper, green | 50-200 g |
| Chili Spur pepper, yellow | 10-50 g |
| Cayenne Pepper | 10-80 g |
| Onion | 10-80 g |
| Garlic | 10-50 g |
| Lemon grass | 10-50 g |
| Coriander root | 5-20 g |
| Galanga | 5-20 g |
| Rind of Citrus hystrix DC | 2-10 g |
| Pepper | 2-10 g |
| Salt | 2-10 g |
| Shrimp paste | 10-80 g |

5. A process of making curry paste of green sweet curry of claim 3 where all the herbal ingredients are cut into small pieces and blended in a food blender until all are thoroughly mixed, salt and shrimp paste are gradually added and mixed to give a homogeneous paste having degree of lightness (L), ranging 35-50; degree of redness (a), ranging 1.5-3.5 and degree of yellowness (b) ranging 20-30, where the pH of the curry paste is in the range 4.50-6.50.

6. A process of making green sweet curry of claim 1, comprising roasting coriander seeds and fennel separately until light brownish color is obtained, then pulverizing; frying said curry paste with vegetable oil while about half of the coconut cream is gradually added and adding pulverized coriander seeds and fennel, adding meat which is cut into small pieces, heating at a medium temperature until meat is well-cooked, adding the rest of coconut cream, fish sauce and Solanum fruits, while adding lastly the rest of the medicinal plants to make green sweet curry having the percentage of fat in the range 8-10%, a total soluble solid of 9.5-11.0%, protein 35-45%, salt 2.5-4.5%, a pH of 5.50-6.50, degree of lightness, L, of 55-65, degree of redness, a, of 0.5-2.0, degree of yellowness, b, of 20-30, where the viscosity of the curry soup is 60-70 centipoises at 25° C. and the water activity is in the range 0.80-1.00.

7. A process for stabilizing curry soup of green sweet curry of claim 6 comprising, after the curry is cooked, steps of keeping curry soup of said green sweet curry warm at a temperature slightly under the boiling temperature of said curry soup, while repeatedly pumping or transferring part of said soup to a level at least 50 cm. above the surface of said curry contained in a vessel and, allowing to fall through the air back, where said transferring action is done for at least 5 minutes.
